(19) United States
(12) Patent Application Publication
(10) Pub. No.: US 2024/0163562 A1
(43) Pub. Date: May 16, 2024

(54) AMBIENT LIGHT SENSING USING IMAGE SENSOR

(71) Applicant: SK hynix Inc., Icheon-si Gyeonggi-do (KR)

(72) Inventor: Ji Hee HAN, Icheon-si Gyeonggi-do (KR)

(73) Assignee: SK hynix Inc., Icheon-si Gyeonggi-do (KR)

(21) Appl. No.: 18/191,798

(22) Filed: Mar. 28, 2023

(30) Foreign Application Priority Data
Nov. 16, 2022 (KR) 10-2022-0153655

(51) Int. Cl. H04N 5/235; G09G 5/10

(52) U.S. Cl. CPC H04N 23/71; H04N 23/72; H04N 23/73; H04N 23/74; H04N 23/76; G09G 5/10; G09G 2360/144

(57) ABSTRACT

An ambient light intensity is measured without a dedicated light intensity sensor and is determined instead using only an image sensor, image data from the image sensor, the luminance values obtained from the image data image sensor setup conditions, and determining when a setup condition sensor is changed or needs to be changed because of ambient brightness in the vicinity of the image sensor.

### CROSS-REFERENCE TO RELATED APPLICATION

The present application claims priority under 35 U.S.C. § 119(a) to Korean patent application number 10-2022-0153655 filed on Nov. 16, 2022, in the Korean Intellectual Property Office, the entire disclosure of which is incorporated by reference herein.

### BACKGROUND

### 1. Technical Field

Various embodiments of the present disclosure relate to technology for measuring a brightness in the vicinity of an image sensor using the image sensor.

### 2. Related Art

Recently, various technologies for increasing battery life have been developed in the field of mobile devices. Particularly, because a Liquid Crystal Display (LCD) and a backlight are one of components consuming large amounts of power, a mobile device minimizes the driving times of the LCD and the backlight depending on the ambient brightness. Here, the mobile device identifies the brightness in the vicinity of the mobile device using an ambient light sensor (or an illuminance sensor).

### SUMMARY

However, when the mobile device further includes a hardware component referred to as an ambient light sensor (or an illuminance sensor) for measuring the ambient brightness, a problem of mounting space and/or a problem of additional power consumption may be caused.

Various embodiments of the present disclosure are directed to an image processor. The image processor may include a receiver configured to receive image data from an image sensor, a luminance calculator configured to calculate a code corresponding to the luminance value of the image data based on the image data, an image sensor controller configured to control the setup condition of the image sensor depending on whether the code is within a designated range, and a brightness measurer configured to output, when the setup condition of the image sensor is changed because the code is out of the designated range, a brightness value in the vicinity of the image sensor, which is identified using the changed setup condition and the code.

An embodiment of the present disclosure may provide for a device. The device may include an image sensor configured to acquire image data under the control of an image processor and the image processor configured to calculate a first code corresponding to the luminance value of first image data based on the first image data received from the image sensor, to adjust the setup condition of the image sensor depending on whether the first code is within a designated range, and to output a brightness value in the vicinity of the image sensor in response to changing the setup condition because the first code is out of the designated range, the brightness value being identified using the changed setup condition and a second code corresponding to second image data captured through the image sensor depending on the changed setup condition.

An embodiment of the present disclosure may provide for a method of measuring a brightness. The method may include calculating a first code corresponding to the luminance value of first image data based on the first image data captured through an image sensor, controlling the setup condition of the image sensor depending on whether the first code is within a designated range, and outputting a brightness in the vicinity of the image sensor in response to changing the setup condition of the image sensor because the first code is out of the designated range, the brightness being identified using the changed setup condition and a second code corresponding to second image data captured through the image sensor depending on the changed setup condition.

### BRIEF DESCRIPTION OF THE DRAWINGS

FIG. 1 is a diagram illustrating a device according to an embodiment of the present disclosure.

FIG. 2A is a diagram illustrating an image sensor according to an embodiment of the present disclosure.

FIG. 2B is a diagram illustrating an image processor according to an embodiment of the present disclosure.

FIG. 3 is a diagram illustrating the flow of a method of measuring a brightness in the vicinity of a device according to an embodiment of the present disclosure.

FIG. 4 is a diagram illustrating in more detail a method of measuring a brightness in the vicinity of a device according to an embodiment of the present disclosure.

FIG. 5A is a grayscale photograph identified by reference numeral 510, illustrating an example of image data provided to an image processor by an image sensor according to an embodiment of the present disclosure.

FIG. 5B depicts one-hundred ninety two (192) groups of adjacent pixels, each group being in a discrete region or section of the photograph 510. The grouped pixels represent luminance averages in their particular regions of the photograph 510.

FIG. 6 is a diagram illustrating a method in which an image processor calculates a code based on image data according to an embodiment of the present disclosure.

FIG. 7 is a diagram illustrating another method in which an image processor calculates a code based on image data according to an embodiment of the present disclosure.

FIG. 8 is a diagram illustrating an example of calculating a code based on at least part of image data according to an embodiment of the present disclosure.

FIG. 9 is a diagram illustrating an operation in which an image processor according to an embodiment of the present disclosure controls an image sensor such that a calculated code is within a designated range.

FIG. 10 is a diagram illustrating a method of identifying a brightness in the vicinity of a device based on a code and a setup condition according to an embodiment of the present disclosure.

FIG. 11 is a diagram illustrating another method of identifying a brightness in the vicinity of a device based on a code and a setup condition according to an embodiment of the present disclosure.

### DETAILED DESCRIPTION

Specific structural or functional descriptions in the embodiments of the present disclosure introduced in this specification or application are only for description of the embodiments of the present disclosure. The descriptions should not be construed as being limited to the embodiments described in the specification or application.

Hereinafter, embodiments of the present disclosure are described with reference to the accompanying drawings in order to describe the present disclosure in detail so that those having ordinary knowledge in the technical field to which the present disclosure pertains can easily practice the present disclosure.

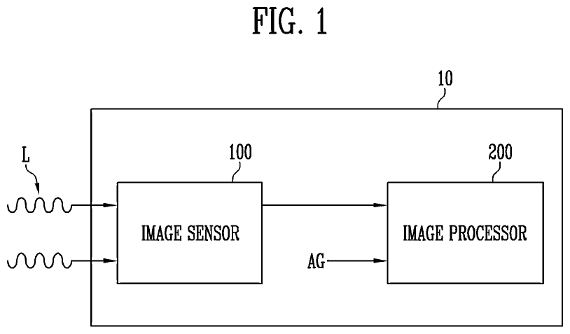

FIG. 1 is a diagram illustrating a device according to an embodiment of the present disclosure.

Referring to FIG. 1, the device 10 may include an image sensor 100 and an image processor 200. For example, the device 10 may correspond to a digital camera, a mobile device, a smartphone, a tablet PC, a Personal Digital Assistant (PDA), an Enterprise Digital Assistant (EDA), a digital still camera, a digital video camera, a Portable Multimedia Player (PMP), a Mobile Internet Device (MID), a Personal Computer (PC), a wearable device, or a device including a multi-purpose camera. Alternatively, the device 10 of FIG. 1 may correspond to a component or module (e.g., a camera module) mounted in other electronic devices.

The image sensor 100 may be implemented as a charge-coupled device (CCD) image sensor or a complementary metal oxide semiconductor (CMOS) image sensor. The image sensor 100 may generate image data for light rays, L, incident through a lens (not illustrated). For example, the image sensor 100 may convert light information of a subject, L, which is incident through a lens, into an electrical signal and provide the electrical signal to the image processor 200. The lens may include at least one lens forming an optical system.

The image sensor 100 may include a plurality of pixels. The image sensor 100 may generate image data corresponding to a captured scene through the plurality of pixels. The image data may include a plurality of pixel values DPXs. Each of the plurality of pixel values DPXs may be a digital pixel value. The image sensor 100 may transmit the generated image data to the image processor 200. That is, the image sensor 100 may provide the image data, including the plurality of pixel values DPXs acquired through the plurality of pixels, to the image processor 200.

The image processor 200 may perform image processing on the image data received from the image sensor 100. For example, the image processor 200 may perform at least one of interpolation, Electronic Image Stabilization (EIS), tonal correction (hue correction), image quality correction, and size adjustment on the image data. The image processor 200 according to the present disclosure may identify the level or intensity of ambient light, which is also referred to herein as brightness, in the vicinity of the device 10, based on, i.e., using the image data. The image processor 200 may be referred to as an image-processing device.

Referring to FIG. 1, the image processor 200 may be implemented as a chip that is physically independent and separate from a chip on which the image sensor 100 is formed. In this case, the chip of the image sensor 100 and the chip of the image processor 200 may be implemented as a single package, e.g., a multi-chip package. However, the image processor 200 may be included with the image sensor 100 as a single chip according to an embodiment of the present disclosure.

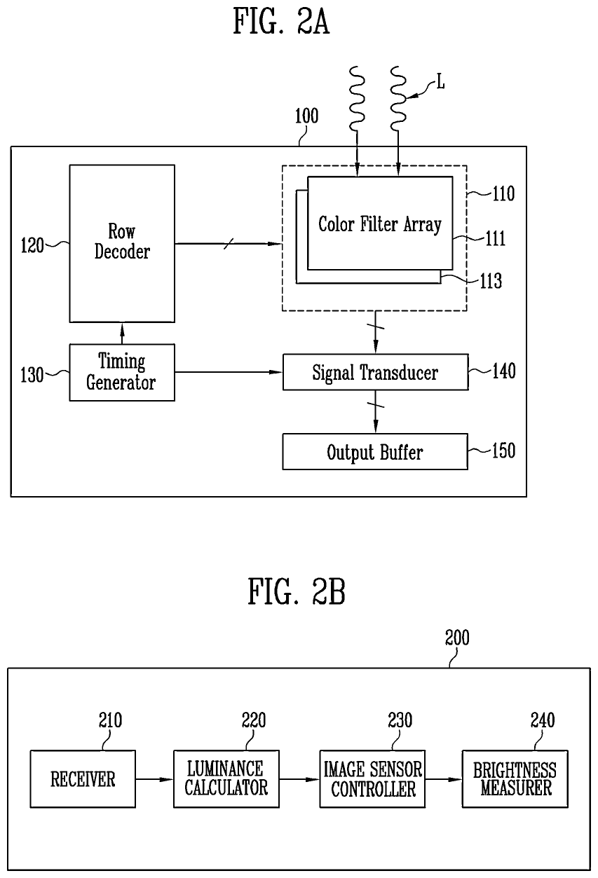

FIG. 2A is a diagram illustrating an image sensor according to an embodiment of the present disclosure.

Referring to FIG. 2A, the image sensor 100 may include a pixel array 110, a row decoder 120, a timing generator 130, a signal transducer 140 and an output buffer 150.

The pixel array 110 may include a plurality of pixels arranged in a row direction and a column direction. Each pixel may generate a plurality of pixel signals VPXs, each signal corresponding to the intensity of light, L, incident thereto. The image sensor 100 may thus generate or “read out” a plurality of pixel signals VPXs for each pixel, in each row of the pixel array 110. Each of the plurality of pixel signals VPXs may be an analog pixel signal.

The pixel array 110 may include a color filter array 111. Each of the plurality of pixels may output a pixel signal corresponding to incident light, L, that passes through the corresponding color filter array 111.

The color filter array 111 may include color filters configured to transmit only a specific wavelength (e.g., red, green, or blue) of light incident to each pixel. Because of the color filter array 111, the pixel signal of each pixel may represent a value corresponding to the intensity of light, L, having a specific wavelength.

The pixel array 110 may include a photoelectric conversion layer 113 including a plurality of photoelectric conversion elements formed under the color filter array 111. Each of the plurality of pixels may generate a photocharge corresponding to the incident light, L, through the photoelectric conversion layer 113. The plurality of pixels may accumulate the generated photocharges and generate pixel signals VPXs corresponding to the accumulated photocharges.

The photoelectric conversion layer 113 may include photoelectric conversion elements corresponding to respective pixels. For example, a photoelectric conversion element may be at least one of a photo diode, a photo transistor, a photogate, and a pinned photo diode. Each pixel of the plurality of pixels may generate photocharges corresponding to light incident on a pixel through the photoelectric conversion layer 113 and generate electrical signals corresponding to the photocharges through at least one transistor.

The row decoder 120 may select one of a plurality of rows in which a plurality of pixels are arranged in the pixel array 110 in response to an address and control signals output from the timing generator 130. The image sensor 100 may read out signals from pixels in a specific row, of the pixel array 110, under the control of the row decoder 120.

The signal transducer 140 may convert analog pixel signals VPXs into digital pixel values DPXs. The signal transducer 140 may perform correlated double sampling (CDS) on each of the plurality of pixel signals VPXs output from the pixel array 110 in response to the control signals output from the timing generator 130 and output the plurality of pixel values DPXs acquired through analog-to-digital conversion of the respective signals on which CDS is performed.

The signal transducer 140 may include a correlated double sampling (CDS) block and an analog-to-digital converter (ADC) block. The CDS block may sequentially sample and hold signals comprising a reference signal and an image signal provided from a column line included in the pixel array 110. Here, the reference signal may correspond to a pixel signal that is read out after a pixel included in the pixel array 110 is reset, and the image signal may correspond to a pixel signal that is read out after the pixel is exposed. The CDS block may acquire a signal having reduced readout noise using the difference between the level of the reference signal corresponding to each of the columns and the level of the image signal corresponding thereto. The ADC block converts the analog signal (e.g., a pixel signal VPXs) for each column, which is output from the CDS block, into a digital signal, thereby outputting the digital signal (e.g., a pixel value DPXs). To this end, the ADC block may include a comparator and a counter corresponding to each column.

The output buffer 150 may be implemented as a plurality of buffers configured to store the digital signals output from the signal transducer 140. Specifically, the output buffer 150 may latch and output the pixel values of each column provided from the signal transducer 140. The output buffer 150 may temporarily store the pixel values output from the signal transducer 140 and sequentially output the pixel values under the control of the timing generator 130. The sequentially output pixel values may be understood as being included in image data. According to an embodiment of the present disclosure, the output buffer 150 may be omitted.

FIG. 2B is a diagram illustrating an image processor according to an embodiment of the present disclosure.

Referring to FIG. 2B, the image processor 200 may include a receiver 210, a luminance calculator 220, an image sensor controller 230, and a brightness measurer 240. Each one of those devices can be implemented with a microprocessor or microcontroller, an application specific integrated circuit (ASIC), or discrete combinational and sequential logic devices implemented as a custom large scale integrated circuit, all of which are well known to those of ordinary skill in the art.

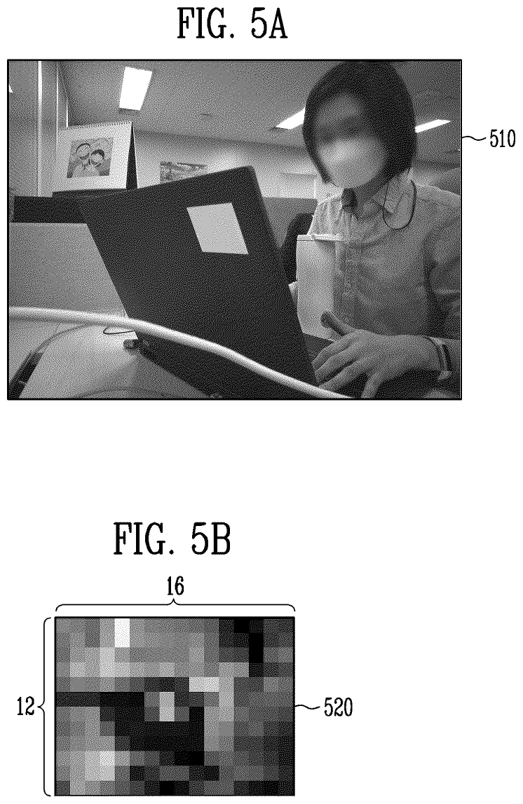

The receiver 210 may receive image data from the image sensor 100. For example, the image processor 200 may receive image data that is captured and output by the image sensor 100. The image data received by the receiver 210 will be described later with reference to FIG. 5.

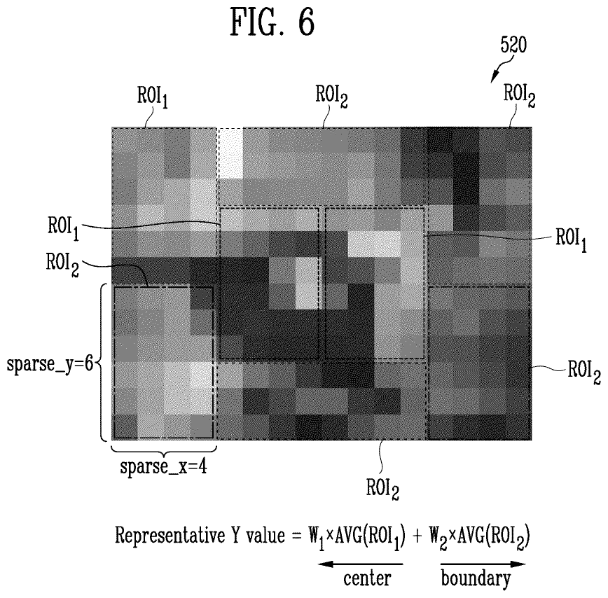

The luminance calculator 220 may calculate a code corresponding to the luminance value of the image data based on the image data. For example, the luminance calculator 220 may calculate a representative luminance value of the image data. A specific method in which the luminance calculator 220 calculates a code based on image data will be described later with reference to FIGS. 6 to 8.

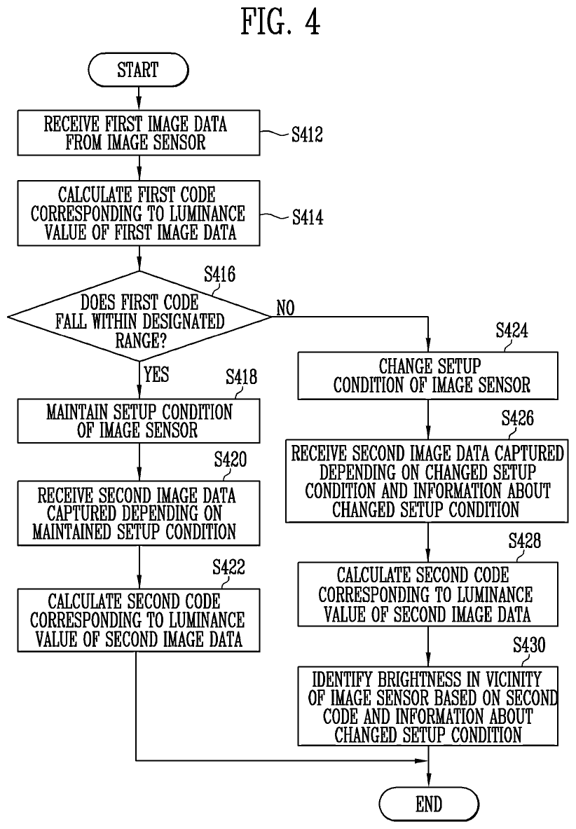

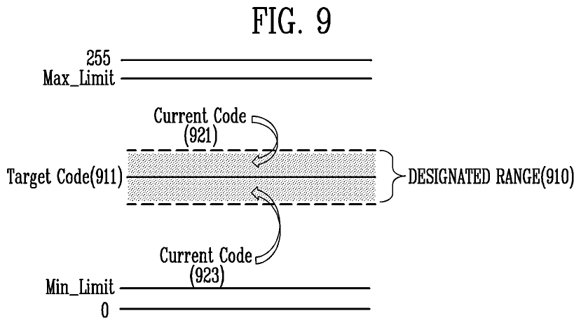

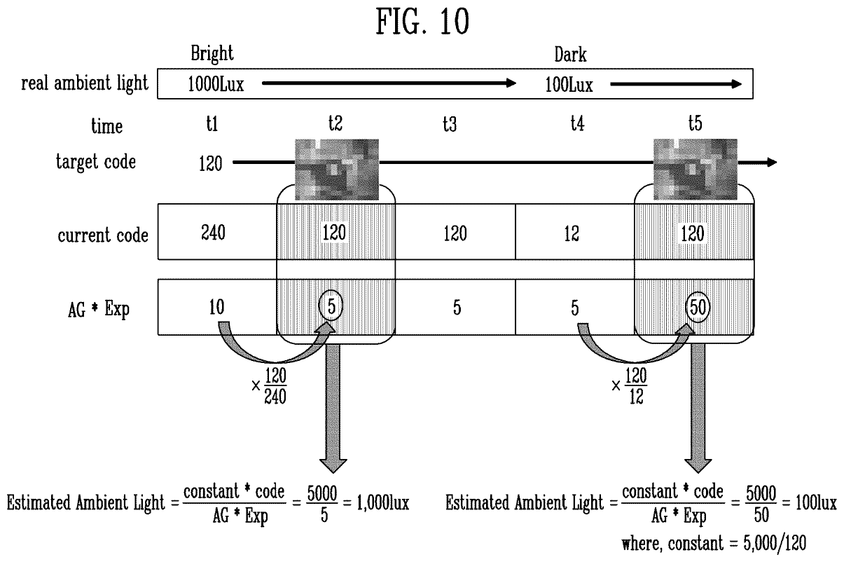

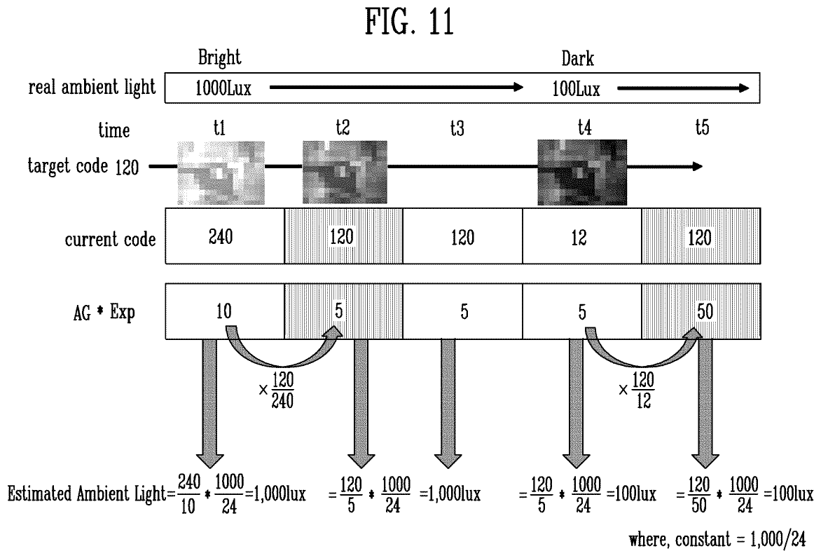

The image sensor controller 230 may control the setup condition of the image sensor 100 depending on whether the code is within a designated range. For example, the image sensor controller 230 may determine whether the code calculated by the luminance calculator 220 is within the designated range. In response to a determination that the code is within the designated range, the image sensor controller 230 may maintain the setup condition of the image sensor 100. Also, in response to a determination that the code is out of the designated range, the image sensor controller 230 may change the setup condition of the image sensor 100. In the present disclosure, the setup condition of the image sensor 100 may include at least one of the analog gain of the image sensor 100 and the exposure time of the image sensor 100. A specific example in which the image sensor controller 230 controls the setup condition of the image sensor 100 will be described later with reference to FIG. 4, FIG. 9, FIG. 10, and FIG. 11.

The brightness measurer 240 may identify a brightness in the vicinity of the image sensor 100 (or a brightness in the vicinity of the device 10) using the setup condition of the image sensor 100 and the code. The brightness measurer 240 may output the identified brightness value. For example, the brightness measurer 240 may provide the brightness value to a processor (e.g., an Application Processor (AP)) which can be implemented using any one or more of the devices identified in paragraph [0040].

The brightness measurer 240 may identify the brightness in the vicinity of the image sensor 100 when the setup condition of the image sensor 100 is changed because the code is out of the designated range. For example, the brightness measurer 240 may identify and output a brightness value in a specific frame, rather than identifying and outputting a brightness value every frame. When it receives information about the setup condition of the image sensor 100 from the image sensor 100, the brightness measurer 240 may measure the brightness in the vicinity of the device 10 using the corresponding information.

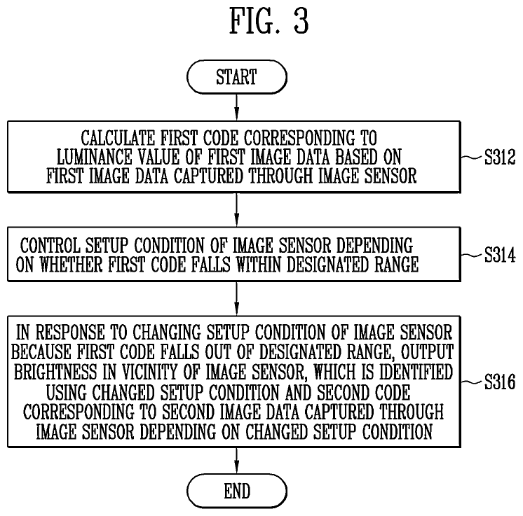

FIG. 3 is a diagram illustrating the flow of a method of measuring a brightness in the vicinity of a device according to an embodiment of the present disclosure. The steps explained in FIG. 3 may be understood as being performed by the device 10 of FIG. 1 or the image processor 200 of FIG. 2B.

At step S312, the image processor 200 (e.g., the luminance calculator 220) may calculate a first code corresponding to the luminance value of first image data based on the first image data captured through the image sensor 100. For example, the image processor 200 (e.g., the luminance calculator 220) may segment the first image data into two or more regions and calculate the first code based on the respective luminance values of the two or more regions. A specific method of calculating the first code based on the first image data will be described later with reference to FIGS. 6 to 8.

At step S314, the image processor 200 (e.g., the image sensor controller 230) may control the setup condition of the image sensor 100 depending on whether the first code is within a designated range. The image processor 200 may set the designated range based on the number of bits of the first code. The designated range will be described later with reference to FIG. 9.

The image processor 200 (e.g., the image sensor controller 230) may maintain the setup condition of the image sensor 100 when the first code is within the designated range, and may change the setup condition of the image sensor 100 when the first code is out of the designated range. The setup condition of the image sensor 100 may include at least one of the analog gain of the image sensor 100 and the exposure time of the image sensor 100. Control of the setup condition of the image sensor 100 will be described later with reference to FIG. 4 and FIG. 9.

At step S316, in response to changing the setup condition of the image sensor 100 because the first code is out of the designated range, the image processor 200 (e.g., the brightness measurer 240) may output the brightness in the vicinity of the image sensor 100 (or the brightness in the vicinity of the device 10), which is identified using the changed setup condition and a second code corresponding to second image data captured through the image sensor 100 depending on the changed setup condition. A specific method of identifying the ambient brightness using the changed setup condition and the second code will be described later with reference to FIG. 10.

In an embodiment, the device 10 may further include a liquid crystal display and a processor configured to control the display. The processor may receive a brightness value, corresponding to the brightness in the vicinity of the device 10, from the image processor 200, and may control the displaying of images on a liquid crystal display using an output brightness value. For example, when the brightness in the vicinity of the device 10 is less than a threshold value (e.g., when it is dark), the processor may reduce the brightness of the display or deactivate the display. In an example, when the brightness in the vicinity of the device 10 is equal to or greater than the threshold value (e.g., when it is bright), the processor may activate the display or increase the brightness of the display.

FIG. 4 is a diagram illustrating in more detail a method of measuring a brightness in the vicinity of a device according to an embodiment of the present disclosure. The steps explained in FIG. 4 may be understood as being performed by the device 10 of FIG. 1 or the image processor 200 of FIG. 2B.

At step S412, the image processor 200 (e.g., the receiver 210) may receive first image data from the image sensor 100. At step S414, the image processor 200 (e.g., the luminance calculator 220) may calculate a first code corresponding to the luminance value of the first image data. Steps S412 and S414 of FIG. 4 may correspond to step S312 of FIG. 3.

At step S416, the image processor 200 (e.g., the image sensor controller 230) may determine whether the first code is within a designated range. The image processor 200 may perform step S418 when the first code is within the designated range, but may perform step S424 when the first code is out of the designated range.

At step S418, the image processor 200 (e.g., the image sensor controller 230) may maintain the setup condition of the image sensor 100 in response to a determination that the first code is within the designated range. At step S420, the image processor 200 (e.g., the receiver 210) may receive second image data, which is captured depending on the maintained setup condition, from the image sensor 100. For example, the image processor 200 may provide a signal for instructing the image sensor 100 to maintain the setup condition. In example, when the setup condition of the image sensor 100 is maintained, the image processor 200 does not provide any signal, and the image sensor 100 may capture second image data without changing the setup condition when no signal is provided from the image processor 200.

At step S422, the image processor 200 (e.g., the luminance calculator 220) may calculate a second code corresponding to the luminance value of the second image data. The method in which the image processor 200 calculates the second code based on the second image data at step S422 may be substantially the same as the method of calculating the first code based on the first image data at step S414.

At step S424, the image processor 200 (e.g., the image sensor controller 230) may change the setup condition of the image sensor 100 in response to a determination that the first code is out of the designated range. Changing the setup condition of the image sensor 100 by the image processor 200 may correspond to driving an auto exposure (AE) function by the image processor 200. For example, the image processor 200 may provide a signal for instructing the image sensor 100 to change the setup condition, and the image sensor 100 may capture second image data depending on the setup condition that is changed under the control of the image processor 200.

In response to a determination that the first code is out of the designated range and has a value above the designated range, the image processor 200 (e.g., the image sensor controller 230) may control the image sensor 100 to decrease the analog gain or to decrease the exposure time. Also, in response to a determination that the first code is out of the designated range and has a value below the designated range, the image processor 200 (e.g., the image sensor controller 230) may control the image sensor 100 to increase the analog gain or to increase the exposure time. A specific method in which the image processor 200 controls the image sensor 100 when the first code is out of the designated range will be described later with reference to FIG. 9.

At step S426, the image processor 200 (e.g., the brightness measurer 240) may receive the second image data captured depending on the changed setup condition and information about the changed setup condition from the image sensor 100.

In an embodiment, when the setup condition of the image sensor 100 is changed at step S424, the image processor 200 (e.g., the image sensor controller 230) may control the image sensor 100 to output information about the changed setup condition along with the second image data. For example, when the image sensor 100 changes the setup condition, the image processor 200 may control the image sensor 100 to output information about at least one of the changed analog gain, the changed exposure time, and the changed analog gain multiplied by the changed exposure time.

At step S428, the image processor 200 (e.g., the luminance calculator 220) may calculate a second code corresponding to the luminance value of the second image data. The method in which the image processor 200 calculates the second code based on the second image data at step S428 may be substantially the same as the method of calculating the first code based on the first image data at step S414.

At step S430, the image processor 200 (e.g., the brightness measurer 240) may identify the brightness in the vicinity of the image sensor 100 (or the brightness in the vicinity of the device 10) based on the second code and the information about the changed setup condition. A specific method of identifying the ambient brightness using the changed setup condition and the second code will be described later with reference to FIG. 9 and FIG. 10.

Comparing steps S418 to S422 with steps S424 to S430 in FIG. 4, it can be seen that the image processor 200 (e.g., the brightness measurer 240) identifies the brightness in the vicinity of the device 10 only when the first code is out of the designated range (or only when the setup condition of the image sensor 100 is changed), and does not identify the brightness in the vicinity of the device 10 otherwise. Here, when an event in which the brightness in the vicinity of the device 10 suddenly changes occurs, the value of the first code rapidly changes and thereby is out of the designated range. That is, the image processor 200 (e.g., the brightness measurer 240) may identify the brightness only when the brightness in the vicinity of the device 10 is rapidly changed by a certain level or more. The configuration in which the brightness in the vicinity of the image sensor 100 is identified in response to changing the setup condition of the image sensor 100 will be described with reference to FIG. 10.

FIG. 5A is a grayscale photograph identified by reference numeral 510 illustrating an example of image data provided to an image processor 200 by an image sensor 100 according to an embodiment of the present disclosure. The photograph 510 is of course made up of many hundreds numerous individual picture elements or pixels. A single pixel of the photograph 510 is too small to be individually discernible in the photograph 510.

FIG. 5B depicts 192 separate, multi-pixel groups, i.e., 192 groups of several pixels that make up the photograph 510. A luminance data 520 may represent luminance values, i.e., 192 luminance values, obtained from each of the multi-pixel groups, i.e., 192 groups. The color of each cell of the luminance data 520 shown in FIG. 5B may indicate an intensity of each the luminance values. Referring now to FIGS. 5A and 5B, the image sensor 100 may convert the original image 510 captured through the pixel array 110 into luminance data 520 for groups of pixels, which are pre-determined numbers of pixels adjacent to each other. Because they are physically close by each other in the image sensor 100, each pixel in a pixel group shown in FIG. 5B will have light impinging on them that has approximately the same intensity level. Stated another way, the intensity of light impinging on pixels that are immediately adjacent to each other in the image sensor 100 will be similar because of their proximity to each other.

The original image 510 will usually have a large number of individual picture elements or pixels, perhaps many hundreds of pixels or more. The total number of pixels in the original image 510 will correspond to the number of pixels included in the entire pixel array 110. The luminance data 520, however, may comprise the luminance values, representing an average luminance of several, immediately-adjacent pixels that form or comprise a pixel group. The luminance data 520 can thus be considered to be the luminance values representing an average luminance of several adjacent pixels of a group of pixels of the image 510, the luminance data 520 having of course a much smaller number of pixels than the total number of pixels that make up the original image 510. For example, a luminance data 520 in FIG. 5B may include the luminance values for 16×12 pixel groups, or 192 pixel groups, the individual pixels of all 192 pixel groups forming the image 510 shown in FIG. 5A.

The luminance data 520 may be computed from a designated number (e.g., 16×12) of the luminance values output from each individual pixel in a group of pixels. Also, each of the luminance values included in the luminance data 520 may have a designated number of luminance levels, each level being represented by a predetermined number of binary digits, (e.g., 8 bit). For example, for the 16×12 array of pixel groups shown in FIG. 5B, the image sensor 100 may output luminance data 520 comprising including 16×12, or 192, 8-bit luminance values.

With regard to ambient light sensing performed by the image processor 200, the image sensor 100 may output the luminance data 520 for the image 510, by converting the original image 510 to luminance data values, (e.g., converting the same into luminance values and/or decreasing the number of pixels thereof). The image processor 200 (e.g., the receiver 210) may receive the luminance data 520 from the image sensor 100. The image processor 200 may calculate the representative luminance value (representative Y value) of the luminance data 520 based on the luminance data 520 received from the image sensor 100. The representative Y value may be a code having a designated number (e.g., 8) of bits.

In the present disclosure, the luminance data 520 may also be referred to as image data (e.g., first image data or second image data), and the representative Y value may be referred to as a code (e.g., a first code or a second code). Each of the first image data and the second image data at steps S312 and S316 of FIG. 3 may be in the form of luminance data 520 of FIG. 5, and each of the first image data and the second image data at steps S412, S414, S420, S422, S426, and S428 of FIG. 4 may also be in the form of luminance data 520.

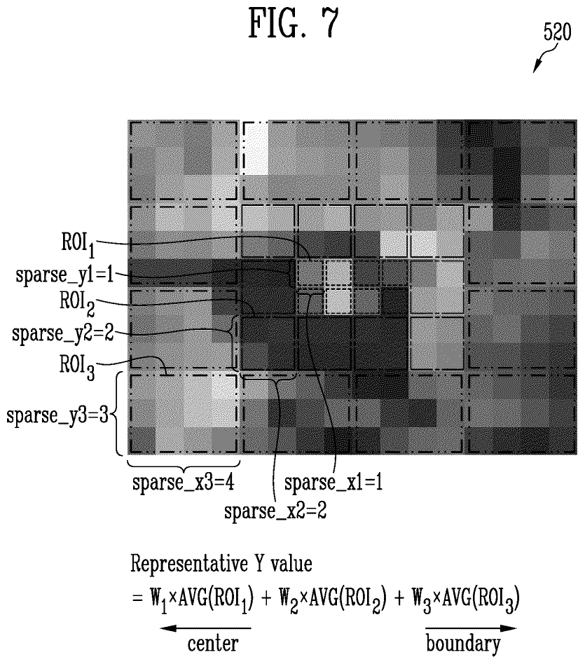

FIG. 6 is a diagram illustrating a method in which an image processor calculates a code based on image data according to an embodiment of the present disclosure. FIG. 7 is a diagram illustrating another method in which an image processor calculates a code based on image data according to an embodiment of the present disclosure.

Two examples of the method of calculating a first code corresponding to the luminance value of first image data based on the first image data, which is the configuration explained at step S312 of FIG. 3 and step S414 of FIG. 4, are described with reference to FIG. 6 and FIG. 7. The luminance data 520 of FIG. 6 and FIG. 7 may correspond to image data (e.g., first image data or second image data), and the representative Y value of FIG. 6 and FIG. 7 may correspond to a code (e.g., a first code or a second code).

The image processor 200 (e.g., the luminance calculator 220) may segment the luminance data 520 into two or more regions and calculate a representative Y value based on the respective luminance values of the two or more regions. For example, the image processor 200 may segment the luminance data 520 into a plurality of regions of interest (ROI). The image processor 200 may then calculate a luminance value of each ROI using at least one luminance value included in the ROI, and add the respective luminance values of the regions of interest (ROI), multiplied by one or more weighting factors thereby calculating a representative Y value of the luminance data 520. That is, the image processor 200 may segment the luminance data 520 into a plurality of regions and calculate the representative Y value through a weighted sum.

Here, as the method in which the image processor 200 segments the luminance data 520 into two or more regions (e.g., regions of interest (ROI)), there is a method of segmenting the luminance data into identical sizes, which is described in FIG. 6. There is also a method of segmenting the luminance data into adaptive sizes, which is described in FIG. 7.

Referring to FIG. 6, the image processor 200 may segment the luminance data 520 received from the image sensor 100 into n regions of interest, two such regions being identified by reference numerals ROI₁ and ROI₂ and shown in FIG. 6 as having the same 4×6 pixel group size. For example, when the luminance data 520 has a size of 16×12 of 192 pixel groups, the image processor 200 may segment the luminance data 520 into regions ROI₁ and ROI₂, each having a size of 4×6 pixel groups. The number of horizontal pixels (sparse_x) of each of the regions ROI₁ and ROI₂ may be 4, and the number of vertical pixels (sparse_y) thereof may be 6. When the size of each region ROI₁ or ROI₂ is 4×6 pixel groups, a grid number may be 8, where (grid number=(width/sparse_x)×(height/sparse_y)=(16/4)×(12/6)=4×2=8).

For example, the image processor 200 may segment the luminance data 520 into two central regions ROI₁ and six boundary regions ROI₂. For example, the image processor 200 may segment the luminance data 520 into two boundary regions ROI₂ on the left side of the central regions ROI₁, two boundary regions ROI₂ on the right side of the central regions ROI₁, and two smaller boundary regions in which luminance values located on the upper and lower sides of the two central regions ROI₁ are reconfigured. Each of the two boundary regions in which the luminance values located on the upper and lower sides of the central regions ROI₁ are located can be reconfigured to regions having a size of 4×6 pixel groups, including a region having a size of 4×3 pixel groups and located on the upper side of any one central region ROI₁ and a region having a size of 4×3 pixel groups and located on the lower side thereof. Alternatively, each of the two boundary regions in which the luminance values located on the upper and lower sides of the central regions ROI₁ are reconfigured may be a region having a size of 8×3 pixel groups and located on the upper side of the central regions ROI₁ or a region having a size of 8×3 pixel groups and located on the lower side thereof. In addition, the image processor 200 may segment the luminance data 520 in any of various manners. For example, the image processor 200 may alternatively segment the luminance data 520 into regions, each having a size of 4×3 pixel groups.

Still referring to FIG. 6, the image processor 200 may apply different weights W₁ and W₂ to the central regions ROI₁, corresponding to the center of the luminance data 520, and the boundary regions ROI₂, corresponding to the boundary of the luminance data 520. For example, the weights W₁ and W₂ may be determined according to a photographing mode, a user's setting, or a position of a subject. The image processor 200 may calculate the representative Y value of the luminance data 520 through Equation (1):

Representative Y value=W₁×AVG(ROI₁)+W₂×AVG(ROI₂) (1)

Referring to Equation (1), the image processor 200 multiplies the average value of the respective luminance values of the central regions ROI₁ (AVG(ROI₁)) by the weight W₁, multiplies the average value of the respective luminance values of the boundary regions ROI₂ (AVG(ROI₂)) by the weight W₂, and adds the two multiplication results, thus calculating the representative Y value.

Referring to FIG. 7, the image processor 200 may alternatively segment the luminance data 520 received from the image sensor 100 into regions ROI₁, ROI₂, and ROI₃ having adaptive sizes. For example, the image processor 200 may determine the regions ROI₁, ROI₂, and ROI₃ to have adaptive sizes, according to the photographing mode, the user's setting, or the position of the subject. The image processor 200 may segment the luminance data 520 into regions ROI₁, ROI₂, and ROI₃ having different sizes from the center of the luminance data 520 to the boundary of the luminance data 520. For example, when the luminance data 520 has a size of 16×12 pixel groups, the image processor 200 may segment the luminance data 520 into regions ROI₁ each having a size of 1×1 pixel groups, regions ROI₂ each having a size of 2×2 pixel groups, and regions ROI₃ each having a size of 4×3 pixel groups in a direction extending from the center of the luminance data 520 pixel groups to the boundaries thereof.

In the case of the regions ROI₁ corresponding to the center of the luminance data 520, the number of horizontal pixels (sparse_x1) may be 1 and the number of vertical pixels (sparse_y1) may be 1. In the case of the regions ROI₂ that are located outwards relative to the region ROI₁ corresponding to the center of the luminance data 520, the number of horizontal pixels (sparse_x2) may be 2 and the number of vertical pixels (sparse_y2) may be 2. In the case of the regions ROI₃ corresponding to the boundary of the luminance data 520, the number of horizontal pixels (sparse_x3) may be 4 and the number of vertical pixels (sparse_y3) may be 3. When the luminance data 520 is segmented as illustrated in FIG. 7, the grid number may be 30, which is the sum of 8, 10, and 12, which are the number of regions ROI₁, the number of regions ROI₂, and the number of regions ROI₃, respectively.

Referring to FIG. 7, the image processor 200 may apply different weights W₁, W₂, and W₃ to the respective regions ROI₁, ROI₂, and ROI₃, which are acquired by segmenting the luminance data 520. The image processor 200 may calculate the representative Y value of the luminance data 520 through Equation (2):

Representative Y value=W₁×AVG(ROI₁)+W₂×AVG(ROI₂)+W₃×AVG(ROI₃) (2)

Referring to Equation (1) of FIG. 6 and Equation (2) of FIG. 7, the image processor 200 may acquire the representative Y value through the weighted sum, which multiplies different weights depending on the location (e.g., the center or the boundary) in the luminance data 520. For example, the image processor 200 may calculate the representative Y value using different methods depending on the difference between the luminance value of the central region (e.g., ROI₁ of FIG. 6) and the luminance value of the boundary region (e.g., ROI₂ of FIG. 6). When the difference between the luminance value of the central region and the luminance value of the boundary region is equal to or greater than a threshold value, the image processor 200 may determine that a subject, such as an object or a human, is included in the scene captured through the image sensor 100, and may calculate the representative Y value using the luminance value of the boundary region, excluding the central region. Also, when the difference between the luminance value of the central region and the luminance value of the boundary region is less than the threshold value, the image processor 200 may calculate the representative Y value using both the central region and the boundary region.

Describing in more detail the case in which the difference between the luminance value of the central region and the luminance value of the boundary region is equal to or greater than the threshold value, the image processor 200 may calculate the standard deviation of the luminance values in the entire boundary region, and may calculate the representative Y value using all of the luminance values included in the boundary region when the standard deviation is lower than a certain level. When the standard deviation is equal to or higher than the certain level, the image processor 200 may calculate the representative Y value using remaining luminance values, excluding the top/bottom N % of the luminance values included in the boundary region. The image processor 200 filters out the top/bottom N % of the luminance values, thus minimizing the effect of outliers that can be included in the luminance data 520.

Similarly, describing in more detail the case in which the difference between the luminance value of the central region and the luminance value of the boundary region is less than the threshold value, the image processor 200 may calculate the representative Y value using remaining luminance values, excluding the top/bottom N % of all of the luminance values of both the central region and the boundary region.

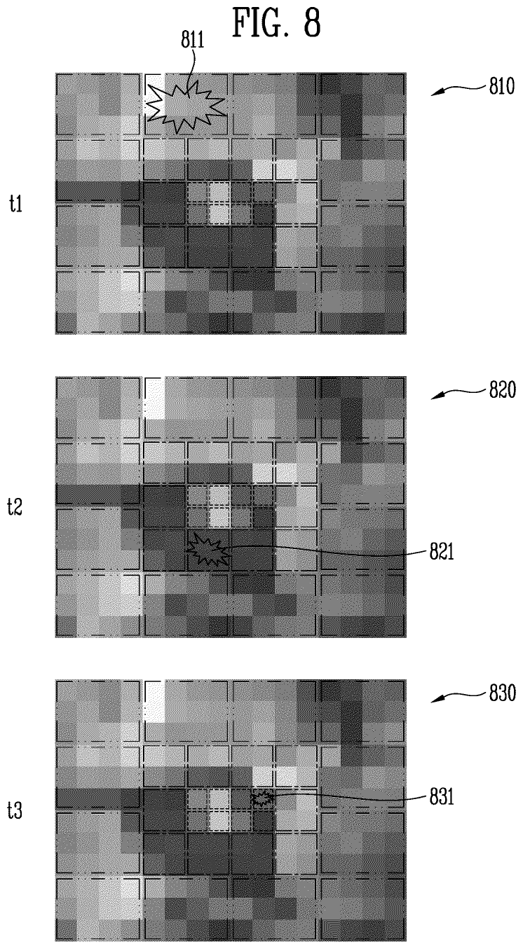

FIG. 8 is a diagram illustrating an example of calculating a code based on at least part of image data according to an embodiment of the present disclosure. Each of the pieces of luminance data 810, 820, and 830 illustrated in FIG. 8 may correspond to the luminance data 520 illustrated in FIG. 5.

Referring to FIG. 8, some regions of the luminance data 520 may include outliers. The outliers may indicate that the luminance value of a specific region of the luminance data 520 has a very large value or a very small value compared to other regions of the luminance data 520. For example, when only some regions of the luminance data 520 have a very large luminance value due to pixel saturation or the like, it may be understood that the corresponding regions include outliers.

The outliers may include spatial variations and temporal variations.

Referring to FIG. 8, a region of the luminance data 810 that is captured at time t1 may include an outlier 811. When the luminance value of the region corresponding to the outlier 811, among all of the regions of the luminance data 810, is out of a certain range, the outlier 811 may correspond to spatial variation. The outlier corresponding to spatial variation may occur when local light (e.g., a point source of light) is included in the captured scene.

Also, comparing the luminance data 810 captured at time t1, the luminance data 820 captured at time t2, and the luminance data 830 captured at time t3, the locations of the outliers 811, 821, and 831 may be different. When the pieces of luminance data 810, 820, and 830 that are captured at different times include the outliers 811, 821, and 831 at different locations, the outliers 811, 821, and 831 may correspond to temporal variation. The outliers corresponding to temporal variation may occur when the capture device 10 (or the image sensor 100) is moved or shaken.

The image processor 200 may calculate the representative Y value using remaining regions, excluding the outliers 811, 821, and 831, in order to improve the accuracy of the representative Y value calculated based on the pieces of luminance data 810, 820, and 830. For example, the image processor 200 may calculate the representative Y value based on at least part of the pieces of luminance data 810, 820, and 830 in order to improve the accuracy of the representative Y value. The image processor 200 may calculate the representative Y value after excluding the outliers 811, 821, and 831, thus preventing the outliers 811, 821, and 831 from causing the representative Y value to be excessively higher or lower than the brightness of the actual scene to be calculated.

For example, the image processor 200 may exclude the outliers corresponding to spatial variation and/or the outliers corresponding to temporal variation by calculating the representative Y value using the remaining luminance values from which the top/bottom N % of the luminance values included in the pieces of luminance data 810, 820, and 830 are removed. However, this is an example, and the representative Y value may be calculated through any of various other methods.

Referring to FIGS. 6 to 8, the image processor 200 (e.g., the luminance calculator 220) may calculate the representative Y value using the luminance data 520 acquired from the image sensor 100. Here, the representative Y value is a code having a designated number of bits (e.g., 8 bits) and may have, for example, a value ranging from 0 to 255. In FIGS. 9 to 11, a method in which the image processor 200 (e.g., the brightness measurer 240) identifies the brightness in the vicinity of the device 10 (or the brightness in the vicinity of the image sensor 100) using the calculated representative Y value, that is, the code, will be described.

FIG. 9 is a diagram illustrating an operation in which an image processor according to an embodiment of the present disclosure controls an image sensor such that a calculated code is within a designated range.

Referring now to the descriptions of FIG. 3 and FIG. 4, the image processor 200 (e.g., the image sensor controller 230) may determine whether the first code (or the representative Y value) calculated based on the first image data (or the luminance data 520) is within a designated range 910, and may change the setup condition of the image sensor 100 in order to make the first code is within the designated range 910 when the first code is out of the designated range 910. In FIG. 9, the reason for making the representative Y value be within the designated range 910, how the designated range 910 is defined, and how to change the setup condition in order to make the representative Y value be within the designated range 910, are described below.

The image processor 200 (e.g., the image sensor controller 230) may perform control such that the representative Y value calculated based on the luminance data 520 is maintained constant. Referring to FIG. 9, when the first code (e.g., the current code 921 or the current code 923) is out of the designated range 910, the image processor 200 changes the setup condition of the image sensor 100, thus making the code (e.g., the second code) subsequent to the first code being within the designated range 910.

The image processor 200 (e.g., the image sensor controller 230) acts to make the representative Y value be within the designated range 910, thus also performing a motion detection function after an ambient light sensing (ALS) function. That is, in order to use the image sensor 100 not only for the ALS function but also for the motion detection function, the device 10 and the image processor 200 may be designed such that the representative Y value consistently falls within the designated range 910. When the average of the luminance data 520 received from the image sensor is maintained constant, the image processor 200 may easily perform the motion detection function.

Accordingly, the image processor 200 determines whether the first code calculated based on the first image data falls within the designated range 910, thus performing both the ALS function and the motion detection function using the image sensor 100.

Referring to FIG. 9, the designated range 910 may be a certain range based on a target code 911. The target code 911 may correspond to a median value, among values capable of being represented through the first code. For example, when the first code has 8 bits, the first code is capable of representing a value ranging from 0 to 255, so the target code 911 may be 128.

The image processor 200 may set the designated range 910 to a range corresponding to 10 to 20% of (MAX+MIN)/2 above and below the target code 911. For example, when the first code has 8 bits, (MAX+MIN)/2 is 128, and the designated range 910 may be 115.2 to 140.8 (in the case of 10%) or 102.4 to 153.6 (in the case of 20%).

The boundary values of the designated range 910 (e.g., 115.2 and 140.8) may be understood as limit values for sensing a change in the brightness value. When the brightness (or the illuminance) in the vicinity of the device 10 changes, the first code calculated based on the first image data is changed, and may thereby fall out of the designated range 910. Here, when the ambient brightness slightly changes, the first code does not fall out of the designated range 910, but when the ambient brightness changes a lot, the first code may fall out of the designated range 910. Therefore, when the first code does not fall out of the designated range 910, the brightness value can be considered as rarely changing or slightly changing, and the boundary value of the designated range 910 may be understood as the limit value for sensing the change of the brightness value.

The image processor 200 may control the setup condition (e.g., the analog gain and the exposure time) of the image sensor 100 depending on whether the first code falls within the designated range 910. In Table 1, a control signal for controlling the setup condition of the image sensor 100 by the image processor 200 depending on the value of the first code is described.

TABLE 1

| | | |
|---|---|---|
| (1) | Current Code > Max_Limit | Exp_Next = Min_Exp, AG_Next = x1 |
| (2) | Current Code < Min_Limit | Exp_Next = Max_Exp, |
| | | AG_Next = Max_Gain |
| (3) | Current Code − TH1 > | Exp_Next * AG_Next = AE |
| | Target_Code | Final Gain * |
| | | Exp_Cur * AG_Cur |
| (4) | Current Code + TH2 < | Exp_Next * AG_Next = AE |
| | Target_Code | Final Gain * |
| | | Exp_Cur * AG_Cur |
| (5) | When Exp cannot be | Exp_Next * AG_Next = AE |
| | used any longer for | Final Gain * |
| | the minimum fps spec | Exp_Cur * AG_Cur |
| (6) | When Current Code is | Exp_Next = Exp_Cur, |
| | similar to Target_Code | AG_Next = AG_Cur |

Referring to Table 1, the image processor 200 may control the analog gain and/or the exposure time for acquisition of the next frame depending on the state of the current code (e.g., the first code). With regard to Table 1, the current code may be the first code, and the next exposure time Exp_Next and the next analog gain AG_Next may be understood as the setup condition of the image sensor 100 related to the second image data.

In the case of (1) of Table 1, the image processor 200 may change the exposure time of the image sensor 100 to the minimum exposure time when it determines that the current code is greater than the maximum limit value Max_Limit. Referring to FIG. 9, the maximum limit value Max_Limit may be a value that is a certain level lower than 255, which is the maximum value capable of being represented using an 8-bit code.

In the case of (2) of Table 1, the image processor 200 may change the exposure time of the image sensor 100 to the maximum exposure time and change the analog gain of the image sensor 100 to the maximum gain when it determines that the current code is less than the minimum limit value Min_Limit. Referring to FIG. 9, the minimum limit value Min_Limit may be a value that is a certain level higher than 0, which is the minimum value capable of being represented using an 8-bit code.

In the case of (3) of Table 1, the image processor 200 may change the product of the next exposure time Exp_Next and the next analog gain AG_Next so as to correspond to the product of the current exposure time Exp_Cur, the current analog gain AG_Cur, and AE Final Gain when it determines that the current code 921 is a first threshold value TH1 or greater than the target code 911. That is, (3) of Table 1 may correspond to the case in which the brightness corresponding to the current code 921 is much brighter than the brightness corresponding to the target code 911. Here, AE Final Gain may be defined by Equation (3):

AE Final Gain=1+(AE Initial Gain−1)×compensate rate,

where, 0≤compensate rate≤1 (3)

‘AE Initial Gain’ included in Equation (3) may be defined by Equation (4):

AE Initial Gain=Target code/Current Code (4)

Referring to Equation (3) and Equation (4), when the current code 921 falls out of the designated range 910, the image processor 200 decrease (exposure time×analog gain) of the image sensor 100 by AE Final Gain, thereby controlling the next code to fall within the designated range 910. In Equation (3), ‘1’ is a term for preventing hunting, and ‘compensate rate’ may be a term for determining whether to compensate for the current code 921 with the target code 911 by 100%. For example, when ‘compensate rate’ is 1, AE Final Gain is multiplied, and then the second code acquired depending on the next exposure time Exp_Next and the next analog gain AG_Next may have the same value as the target code 911.

In the case of (4) of Table 1, the image processor 200 may change the product of the next exposure time Exp_Next and the next analog gain AG_Next so as to correspond to the product of the current exposure time Exp_Cur, the current analog gain AG_Cur, and AE Final Gain when it determines that the current code 923 is a second threshold value TH2 or more less than the target code 911. That is, (4) of Table 1 may correspond to the case in which the brightness corresponding to the current code 923 is much darker than the brightness corresponding to the target code 911. ‘AE Final Gain’ included in (4) of Table 1 may correspond to ‘AE Final Gain’ described in Equation (3) and Equation (4).

In the case of (5) of Table 1, even when it is difficult to increase the exposure time of the image sensor 100 any more in consideration of a frame rate (fps), the image processor 200 may change the product of the next exposure time Exp_Next and the next analog gain AG_Next so as to correspond to the product of the current exposure time Exp_Cur, the current analog gain AG_Cur, and AE Final Gain.

In the case of (6) of Table 1, when the current code is similar to the target code 911, that is, when the current code falls within the designated range 910, the image processor 200 may maintain the exposure time and the analog gain by setting the next exposure time Exp_Next to be the same as the current exposure time Exp_Cur and setting the next analog gain AG_Next to be the same as the current analog gain AG_Cur.

Referring to the description made in Table 1, the setup condition (e.g., the analog gain and the exposure time) of the image sensor 100, which is changed by the image processor 200 depending on the value of the current code, may have a continuous value. For example, the setup condition of the image sensor 100 according to the present disclosure may have a relatively continuous value, rather than having only n fixed values. That is, the steps between the values to which the setup condition of the image sensor 100 can be set may be dense.

Accordingly, the device 10 according to the present disclosure finely adjusts the analog gain and exposure time of the image sensor 100, thereby controlling the image sensor 100 such that the representative Y value (or the code) falls within the designated range 910.

FIG. 10 is a diagram illustrating a method of identifying a brightness in the vicinity of a device based on a code and a setup condition according to an embodiment of the present disclosure.

Referring to step S316 of FIG. 3, the image processor 200 (e.g. the brightness measurer 240) may identify the brightness in the vicinity of the image sensor 100 (or the brightness in the vicinity of the device 10) using the changed setup condition of the image sensor 100 and the second code corresponding to the second image data captured depending on the changed setup condition. The image processor 200 may measure an ambient brightness (or an ambient illuminance) using Equation (5):

$$Estimated Ambient Light = \frac{constant * code}{AG * Exp} \qquad ( 5 )$$

The image processor 200 (e.g., the brightness measurer 240) substitutes the analog gain of the image sensor 100, the exposure time thereof, and the second code corresponding to the luminance value of the second image data into Equation (5), thereby estimating the ambient light at the time at which the second image data is captured.

Referring to steps S426 to S430 of FIG. 4, the image processor 200 may receive information about the changed setup condition along with the second image data from the image sensor 100, and may identify the ambient brightness based on the second code and the information about the changed setup condition. Referring to FIG. 10, the image sensor 100 may output the product of the analog gain and the exposure time (AG*Exp) in a specific frame, and the image processor 200 may measure the ambient brightness using Equation (5) only when it receives AG*Exp. Accordingly, in FIG. 10, the configuration in which the image processor 200 identifies the brightness in the vicinity of the image sensor 100 when it changes the setup condition of the image sensor 100 is described in more detail.

In FIG. 10, when the brightness of the real ambient light becomes dark by changing from 1000 Lux to 100 Lux after time t4, the operations of the image sensor 100 and the image processor 200 are illustrated. The target code 911 may be 120.

Depending on the luminance data captured at time t1, the code calculated by the luminance calculator 220 may be 240. The image processor 200 (e.g., the image sensor controller 230) may determine that 240 falls out of the designated range (that is, a certain range based on the target code having a value of 120). Referring to (3) of Table 1, the image processor 200 may set the product of the next exposure time Exp_Next of the image sensor 100 and the next analog gain AG_Next thereof so as to correspond to the product of the current exposure time Exp_Cur, the current analog gain AG_Cur, and AE Final Gain. For example, because AE Final Gain=1+(120/240−1)×1=120/240 is satisfied in the case of FIG. 10, the image processor 200 may multiply (exposure time×analog gain) of the image sensor 100 by 0.5 (×0.5).

At time t2, the image sensor 100 may capture luminance data depending on the changed setup condition. Because the image processor 200 changes at least one of the exposure time and the analog gain of the image sensor 100, the code of the luminance data captured at time t2 may be 120, which matches the target code. Here, the image sensor 100 may provide the image processor 200 with the value of AG*Exp along with the luminance data captured at time t2. Because (exposure time×analog gain) of the image sensor 100 is decreased to 0.5 times its original value, the value of AG*Exp output by the image sensor 100 may be 5.

The image processor 200 (e.g., the brightness measurer 240) substitutes 120, which is the code related to time t2, and 5, which is the value of AG* Exp, into Equation (5), thereby identifying the brightness in the vicinity of the image sensor 100. In FIG. 10, ‘constant’ in Equation (5) may be 5000/120. Here, ‘constant’ in Equation (5) may be a value that is preset using the external brightness and the value of the code calculated depending on the setup condition of the image sensor 100. Accordingly, the image processor 200 may identify the ambient brightness=5000/5=1000 Lux based on the code related to time t2, which is 120, and the information about the changed setup condition, which is AG*Exp=5.

At time t2, because the code having a value of 120 equals to the target code having a value of 120, the image processor 200 (e.g., the image sensor controller 230) may determine that the code falls within the designated range. When the code falls within the designated range, the image processor 200 may maintain the setup condition of the image sensor 100. Accordingly, at time t3, AG*Exp of the image sensor 100 may be maintained constant. Referring to FIG. 10, because the setup condition of the image sensor 100 and the real ambient light are maintained constant at time t3, the code may also be maintained at 120.

When the real ambient light decreases to 100 Lux at time t4, the code calculated based on the luminance data captured at time t4 may decrease to 12. The image processor 200 (e.g., the image sensor controller 230) may determine that the code, 12, falls out of the designated range. Referring to (4) in Table 1, the image processor 200 may set the product of the next exposure time Exp_Next of the image sensor 100 and the next analog gain AG_Next thereof so as to correspond to the product of the current exposure time Exp_Cur, the current analog gain AG_Cur, and AE Final Gain. For example, because AE Final Gain=1+(120/12−1)×1=120/12 is satisfied in the case of FIG. 10, the image processor 200 may multiply the (exposure time×analog gain) of the image sensor 100 by 10 (x 10).

At time t5, the image sensor 100 may capture luminance data depending on the changed setup condition. Because the image processor 200 changes at least one of the exposure time of the image sensor 100 and the analog gain thereof, the code of the luminance data captured at time t5 may be 120, which matches the target code. Here, the image sensor 100 may provide the image processor 200 with the value of AG*Exp along with the luminance data captured at time t5. Because (exposure time×analog gain) of the image sensor 100 increases to 10 times its original value, the value of AG*Exp output by the image sensor 100 may be 50.

The image processor 200 (e.g., the brightness measurer 240) substitutes 120, which is the code related to time t5, and 50, which is the value of AG* Exp, into Equation (5), thereby identifying the brightness in the vicinity of the image sensor 100. In FIG. 10, ‘constant’ in Equation (5) may be 5000/120. Accordingly, the image processor 200 may identify the ambient light=5000/50=100 Lux based on the code related to time t5, which is 120, and the information about the changed setup condition, which is AG*Exp=50.

With regard to FIG. 10, it can be seen that the image processor 200 performs an auto exposure (AE) function between time t1 and time t2, locks the AE function between time t2 and time t3 because the code is stable, unlocks the AE function between time t3 and time t4 because the code is unstable, and performs the AE function between time t4 and time t5.

The image sensor 100 according to the present disclosure may output information about the setup condition (e.g., AG*Exp) in response to changing the setup condition under the control of the image processor 200. That is, the image sensor 100 may provide the image processor 200 with AG*Exp only when the current code matches the target code as the result of performing the AE function. The image sensor 100 outputs AG*Exp only in a specific frame, rather than outputting AG*Exp every frame, whereby the image processor 200 may perform a motion detection function as well as measurement of the ambient brightness using the luminance data received from the image sensor 100. In order for the image processor 200 to sense the motion of the device 10, it is advantageous to constantly maintain the brightness of the luminance data output from the image sensor 100. According to the description made in FIG. 10, because there is no or little variation in the brightness value of the luminance data output by the image sensor 100, it may be easy for the image processor 200 to sense the motion based on the luminance data.

In response to changing the setup condition of the image sensor 100, the image processor 200 according to the present disclosure may identify and output the brightness value in the vicinity of the image sensor 100. Because the image sensor 100 outputs information about the setup condition in response to changing the setup condition under the control of the image processor 200, the image processor 200 may identify the brightness value only when the information about the setup condition is received from the image sensor 100. That is, according to the embodiment described in FIG. 10, the image processor 200 may neither identify nor output the brightness value when the setup condition of the image sensor 100 is not changed. When the code falls out of the designated range while the device 10 according to the present disclosure is being driven, this may indicate that the brightness in the vicinity of the device 10 changes by a certain level or more. Accordingly, the device 10 identifies the brightness value when the code falls out of the designated range, but may not output the brightness value otherwise. As a result, the device 10 may reduce the amount of power consumed for measuring the brightness value.

FIG. 11 is a diagram illustrating another method of identifying a brightness in the vicinity of a device based on a code and a setup condition according to an embodiment of the present disclosure.

Unlike the embodiment described in FIG. 4 and FIG. 10, the image processor 200 may measure the ambient brightness by receiving information about the setup condition (e.g., AG*Exp) from the image sensor 100 every frame according to the embodiment described in FIG. 11.

Referring to FIG. 11, the real ambient light, the target code, the current code, and control of the setup condition of the image sensor 100 may match those in the embodiment of FIG. 10. However, according to FIG. 11, the image sensor 100 may output the information about the setup condition (e.g., AG*Exp) even though the setup condition is not changed (or even though the current code does not match the target code).

The image processor 200 may measure the ambient brightness every frame using the information about the setup condition (e.g., AG*Exp), which is output along with the luminance data by the image sensor 100. For example, the image processor 200 may identify the ambient brightness=(240/10)×(1000/24)=1000 Lux in connection with the image data captured at time t1. Also, the image processor 200 may identify the ambient brightness=(120/5)×(1000/24)=1000 Lux in connection with the image data captured at time t2 and time t3. The image processor 200 may identify the ambient brightness=(12/5)×(1000/24)=100 Lux in connection with the image data captured at time t4, and may identify the ambient brightness=(120/50)×(1000/24)=100 Lux in connection with the image data captured at time t5.

The image processor 200 may identify the ambient brightness using AG*Exp, which is provided in response to changing the setup condition of the image sensor 100, as in the embodiment of FIG. 10, and may alternatively identify the ambient brightness using AG*Exp that is always provided regardless of whether the setup condition of the image sensor 100 is changed, as in the embodiment of FIG. 11. That is, even though the current code does not match the target code or falls out of the designated range, the image processor 200 may identify the brightness of ambient light. However, considering a motion detection function, it may be advantageous for the image sensor 100 to output the value of AG*Exp only in a specific frame as in the embodiment of FIG. 10, compared to the embodiment of FIG. 11.

As stated above, the receiver, which essentially processes data, may be embodied as a conventional processor, an ASIC or combinational and sequential logic devices on an LSI device. A luminance calculator, image sensor controller and brightness measurer can also be embodied as a conventional processor, an ASIC or combinational and sequential logic devices on an LSI devices.

Those of ordinary skill in the art will appreciate the performance and cost advantages of determining ambient brightness using an image sensor, i.e., determining ambient brightness without having to use a dedicated and thus single function ambient light sensor. An image sensor as disclosed and claimed hereinafter may thus obviate the need for a dedicated ambient light sensor (or an illuminance sensor) in virtually any type of image-capturing device.

The foregoing is for illustration purposes. The true scope of the disclosure is defined by the appurtenant claims.

What is claimed is:

1. An image processor, comprising:
a receiver configured to receive image data from an image sensor;
a luminance calculator configured to calculate a code value that corresponds to a luminance value of the image data;
an image sensor controller configured to control a setup condition of the image sensor depending on whether the calculated code is within a designated range; and
a brightness measurer configured to output a value representing ambient brightness in a vicinity of the image sensor in response to changing the setup condition of the image sensor when the code is outside of the designated range, the ambient brightness value being identified using the changed setup condition and the code.

2. The image processor according to claim 1, wherein the luminance calculator segments the image data into two or more regions and calculates the code based on respective luminance values of the two or more regions.

3. The image processor according to claim 1, wherein the designated range is based on a median luminance value, among values capable of being represented through the calculated code.

4. The image processor according to claim 1, wherein the image sensor controller maintains the setup condition of the image sensor in response to a determination that the calculated code is within the designated range of values.

5. The image processor according to claim 1, wherein the setup condition includes at least one of an analog gain of the image sensor and an exposure time of the image sensor.

6. The image processor according to claim 5, wherein the image sensor controller decreases the analog gain or the exposure time of the image sensor in response to a determination that the code falls out of the designated range of values and has a value above the designated range of values.

7. The image processor according to claim 5, wherein the image sensor controller increases the analog gain or the exposure time of the image sensor in response to a determination that the code is outside the designated range of values and has a value below the designated range of values.

8. The image processor according to claim 1, wherein, when the setup condition of the image sensor is changed, the brightness measurer identifies the brightness value using information about the changed setup condition received along with the image data from the image sensor.

9. The image processor according to claim 1, wherein the brightness measurer does not output the brightness value in response to maintaining the setup condition of the image sensor because the code falls within the designated range of values.

10. A device, comprising:
an image sensor configured to acquire image data under control of an image processor; and
the image processor configured to calculate a first code corresponding to a luminance value of first image data based on the first image data received from the image sensor, to adjust a setup condition of the image sensor depending on whether the first code is within a designated range of values, and to output a brightness value in a vicinity of the image sensor in response to changing the setup condition because the first code is outside the designated range of values, the brightness value being identified using the changed setup condition and a second code corresponding to second image data captured through the image sensor depending on the changed setup condition.

11. The device according to claim 10, further comprising:
a display; and
a processor configured to control displaying of the display based on the output brightness value.

12. A method of measuring a brightness, comprising:
calculating a first code corresponding to a luminance value of first image data based on the first image data captured through an image sensor;
controlling a setup condition of the image sensor depending on whether the first code is within a designated range of values; and
in response to changing the setup condition of the image sensor because the first code falls out of the designated range of values, outputting a brightness in a vicinity of the image sensor, which is identified using the changed setup condition and a second code corresponding to second image data captured through the image sensor depending on the changed setup condition.

13. The method according to claim 12, wherein calculating the first code based on the first image data comprises:
segmenting the first image data into two or more regions; and
calculating the first code based on respective luminance values of the two or more regions.

14. The method according to claim 12, wherein the designated range corresponds to a certain range based on a median value, among values capable of being represented through the first code.

15. The method according to claim 12, wherein controlling the setup condition of the image sensor depending on whether the first code is within the designated range of values comprises:
maintaining the setup condition of the image sensor in response to a determination that the first code is within the designated range of values.

16. The method according to claim 12, wherein the setup condition includes at least one of an analog gain of the image sensor and an exposure time of the image sensor.

17. The method according to claim 16, wherein changing the setup condition of the image sensor because the first code is outside the designated range of values comprises:
in response to a determination that the first code is outside the designated range of values and has a value above the designated range of values, controlling the image sensor to decrease the analog gain or to decrease the exposure time.

18. The method according to claim 16, wherein changing the setup condition of the image sensor because the first code is outside the designated range of values comprises:
in response to a determination that the first code is outside the designated range of values and has a value below the designated range of values, controlling the image sensor to increase the analog gain or to increase the exposure time.

19. The method according to claim 12, wherein identifying the brightness in the vicinity of the image sensor in response to changing the setup condition comprises:
when the setup condition of the image sensor is changed, controlling the image sensor to output information about the changed setup condition along with the second image data.

20. The method according to claim 19, wherein identifying the brightness in the vicinity of the image sensor in response to changing the setup condition comprises:
receiving the second image data and the information about the changed setup condition from the image sensor;
calculating the second code corresponding to a luminance value of the second image data based on the second image data; and
identifying the brightness in the vicinity of the image sensor based on the second code and the information about the changed setup condition.
